(19) United States
(12) Patent Application Publication
(10) Pub. No.: US 2025/0141195 A1
(43) Pub. Date: May 1, 2025

(54) HIGH VOLTAGE GAS INSULATED SWITCHGEAR, HV GIS, FOR SINGLE OR THREE PHASE OPERATION

(71) Applicant: Hitachi Energy Ltd, Zürich (CH)

(72) Inventor: Hauke PETERS, Hanau (DE)

(21) Appl. No.: 18/682,799

(22) PCT Filed: Aug. 10, 2022
(86) PCT No.: PCT/EP2022/072418

§ 371 Date: Feb. 9, 2024

(30) Foreign Application Priority Data
Aug. 10, 2021 (EP) 21190684.7

(51) Int. Cl. H02B 13/035; H02B 13/045; H02B 13/055; H02B 13/075

(52) U.S. Cl. CPC H02B 13/0352; H02B 13/0358; H02B 13/045; H02B 13/055; H02B 13/075

(57) ABSTRACT

A high voltage gas insulated switchgear, HV GIS, includes
a plurality of disconnector modules associated to each phase and filled with an insulating gas, each including a disconnector for connecting a feeder connection to a main bus bar, the disconnector modules interconnected with the main bus bar associated to each phase and extending through all disconnector modules, and
a plurality of auxiliary modules associated to each phase, filled with the insulating gas and interconnected with an auxiliary bus bar configured for increasing a current carrying capability of the HV GIS and associated to each phase and extending through all auxiliary modules,
at least two of the disconnector modules and auxiliary modules of the respective phase including a coupling connection connecting the main bus bar and the auxiliary bus bar between the respective disconnector module and the respective auxiliary module.

### CROSS REFERENCE TO RELATED APPLICATIONS

This application is a 35 U.S.C. § 371 national stage application of PCT International Application No. PCT/EP2022/072418 filed on Aug. 10, 2022, which in turn claims foreign priority to European Patent Application No. 21190684.7, filed on Aug. 10, 2021, the disclosures and content of which are incorporated by reference herein in their entirety.

### TECHNICAL FIELD

The disclosure relates to a high voltage gas insulated switchgear, HV GIS, for single or three phase operation, comprising a plurality of disconnector modules associated to each phase, whereby the disconnector modules are filled with an insulating gas and are interconnected with a main bus bar associated to each phase and extending through all disconnector modules thereby forming a main housing for the respective phase with the insulating gas surrounding the main bus bar.

### BACKGROUND ART

Gas-insulated switchgear, GIS, is typically operated in a medium voltage regime of 10 kV to 100 kV and/or in a high voltage regime of 100 kV to 1200 kV. To insulate a high or medium voltage component, such as for example a disconnector module, a fuse and/or a circuit breaker, the GIS is filled with an insulating gas such as air or SF6. Other gases are also used and currently under development by different manufacturers.

### SUMMARY

It is therefore an object of the disclosure to provide a possibility for increasing current carrying capability of a high voltage gas insulated switchgear, HV GIS, for single or three phase operation, for in case when an accumulation of feeder currents exceeds a rated current of a busbar of the HV GIS, without an existing HV GIS.

The object of the disclosure is solved by the features of the independent claims. Example implementations are detailed in the dependent claims.

Thus, the object is solved by a high voltage gas insulated switchgear, HV GIS, for single or three phase operation, comprising
a plurality of disconnector modules associated to each phase, whereby the disconnector modules are filled with an insulating gas, each disconnector module comprises a disconnector configured for connecting a feeder connection to a main bus bar and the disconnector modules are interconnected with the main bus bar associated to each phase and extending through all disconnector modules thereby forming a main housing for the respective phase with the insulating gas surrounding the main bus bar, and
a plurality of auxiliary modules associated to each phase, whereby the auxiliary modules are filled with the insulating gas and are interconnected with an auxiliary bus bar configured for increasing a current carrying capability of the HV GIS and associated to each phase and extending through all auxiliary modules thereby forming an auxiliary housing for the respective phase with the insulating gas surrounding the auxiliary bus bar, whereby
at least two of the disconnector modules and auxiliary modules of the respective phase comprise a coupling connection connecting the main bus bar and the auxiliary bus bar between the respective disconnector module and the respective auxiliary module.

The object is also solved by a high voltage gas insulated switchgear, HV GIS, for single or three phase operation, comprising
a plurality of disconnector modules associated to each phase, whereby the disconnector modules are filled with an insulating gas and are interconnected with a main bus bar associated to each phase and extending through all disconnector modules thereby forming a main housing for the respective phase with the insulating gas surrounding the main bus bar, and
a plurality of auxiliary modules associated to each phase, whereby the auxiliary modules are filled with the insulating gas and are interconnected with an auxiliary bus bar associated to each phase and extending through all auxiliary modules thereby forming an auxiliary housing for the respective phase with the insulating gas surrounding the auxiliary bus bar.

It is therefore an object of the disclosure that an auxiliary housing comprising the plurality of auxiliary modules interconnected by the auxiliary bus bar is basically ‘added’ to the main housing. Thereby a plurality of auxiliary housings can be provided attached to the main housing with the respective auxiliary modules connected in series and/or in parallel to the respective disconnector module. For example, the gas insulated switchgear, HV GIS, may have one main housing and two auxiliary housings connected in parallel. Also, the auxiliary housings may not extend over the full length of the HV GIS. This means that the auxiliary housings may only be attached to some of the main housings, in particular in areas where the current is to be higher than rated current of the main housing module. It is also possible to prepare the HV GIS for later upgrade by additional auxiliary housings if the main housing modules are planned with a fourth flange in front close by a cover. It thus becomes possible to add the auxiliary housing modules later if the power demands has increased over time.

According to an implementation each disconnector module comprises a disconnector configured for connecting a feeder connection to the main bus bar,

According to an implementation at least two of the disconnector modules and auxiliary modules of the respective phase comprise a coupling connection connecting the main bus bar and the auxiliary bus bar between the respective disconnector module and the respective auxiliary module.

According to an implementation the auxiliary housing is detachably attached to the main housing and/or the auxiliary housing is provided separate to the main housing.

According to an implementation the HV GIS comprises a plurality of auxiliary housings attached to the main housing with the respective auxiliary modules connected in series and/or in parallel to the respective disconnector module.

According to an implementation each of the plurality auxiliary housings comprises an increased number of auxiliary modules, whereby an increased number of respective auxiliary modules are connected in series and/or in parallel to the respective disconnector module.

According to an implementation the auxiliary modules are connected to the disconnector modules on the opposite side to the feeder connection.

According to an implementation the auxiliary modules and the disconnector modules are interconnected with the insulating gas surrounding the coupling connections.

According to an implementation all disconnector modules and auxiliary modules are connected by the respective coupling connection or whereby the disconnector modules and auxiliary modules are connected in regular intervals by the respective coupling connection.

According to an implementation the main bus bar and the auxiliary bus bar extend parallel to each other and/or the coupling connection extends perpendicular to the main bus bar and/or the auxiliary bus bar.

According to an implementation the disconnector module comprises a circuit breaker and/or an earthing switch connected to the main bus bar. The disconnector module and/or the auxiliary module can also be provided as a fuse, a disconnector etc.

According to an implementation the main bus bar is configured for a rating of at least 3000 A, in particular at least 3150 A, and/or the auxiliary bus bar is configured for a rating of at least 2500 A. The HV gas-insulated switchgear, GIS, may be configured for operating in a high voltage regime of 100 kV to 1200 kV.

According to an implementation the main housing comprises at least one additional module associated to each phase, the additional module is arranged between two disconnector modules, is filled with the insulating gas and interconnected with the main bus bar extending through the additional module, and the additional module is connected with one of the auxiliary modules by coupling connection.

According to an implementation the insulating gas comprises at least one of SF6, Airplus C5K, C4FN, CO2-02 and pressurized air and/or any mixture thereof. Generally, various possibilities exist for the insulating gas. Sulfur hexafluoride, SF6, is traditionally the insulating gas of choice for high voltage applications. The symmetrical arrangement of the molecules leads to extreme stability and a very high dielectric capability. SF6 has approximately three times the dielectric strength of air at atmospheric pressure. As a result, GIS using SF6 as an insulating gas can be considerably more compact than equipment using air as the insulating medium. Further, SF6 is a “self-healing” dielectric in that it is largely undamaged by breakdown. This makes SF6 highly suitable as an interrupting medium. Besides SF6 other insulating gases are under development as more climate friendly alternatives to SF6, which can be equally used for the proposed solution.

The objective is further solved by a method for operating a high voltage gas insulated switchgear, HV GIS, as described before.

The objective is further solved by a method for operating a high voltage gas insulated switchgear, HV GIS, for single or three phase operation, comprising the steps of:
Providing a plurality of disconnector modules associated to each phase, whereby the disconnector modules are filled with an insulating gas and are interconnected with a main bus bar associated to each phase and extending through all disconnector modules thereby forming a main housing for the respective phase with the insulating gas surrounding the main bus bar, and
Providing a plurality of auxiliary modules associated to each phase, whereby the auxiliary modules are filled with the insulating gas and are interconnected with an auxiliary bus bar associated to each phase and extending through all auxiliary modules thereby forming an auxiliary housing for the respective phase with the insulating gas surrounding the auxiliary bus bar.

According to an implementation the method comprises the step of:
Connecting the main bus bar and the auxiliary bus bar between the respective disconnector module and the respective auxiliary module of the respective phase with a coupling connection.

The objective is further solved by a wind turbine comprising a high voltage gas insulated switchgear, HV GIS, as described before, whereby the feeder connection connects the wind turbine to the HV GIS. In some examples, a plurality of wind turbines are provided, which are each connected to the HV GIS. Since collection nodes of a wind farm comprising the plurality of wind turbines connects many wind turbines to a busbar via the feeders, the summarized currents may lead to an overload or increased requirements in the busbar. With the proposed auxiliary housings comprising the auxiliary bus bars such problem can be mitigated.

Further implementations and advantages of the method are directly and unambiguously derived by the person skilled in the art from the switchgear as described before.

### BRIEF DESCRIPTION OF DRAWINGS

These and other aspects of the disclosure will be apparent from and elucidated with reference to the implementations described hereinafter.

In the drawings:

FIG. 1 shows an example implementation of a high voltage gas insulated switchgear, HV GIS, having one main housing and one auxiliary housing, and

FIG. 2 shows a further example implementation of the high voltage gas insulated switchgear, HV GIS, having one main housing and two auxiliary housings.

### DESCRIPTION OF IMPLEMENTATIONS

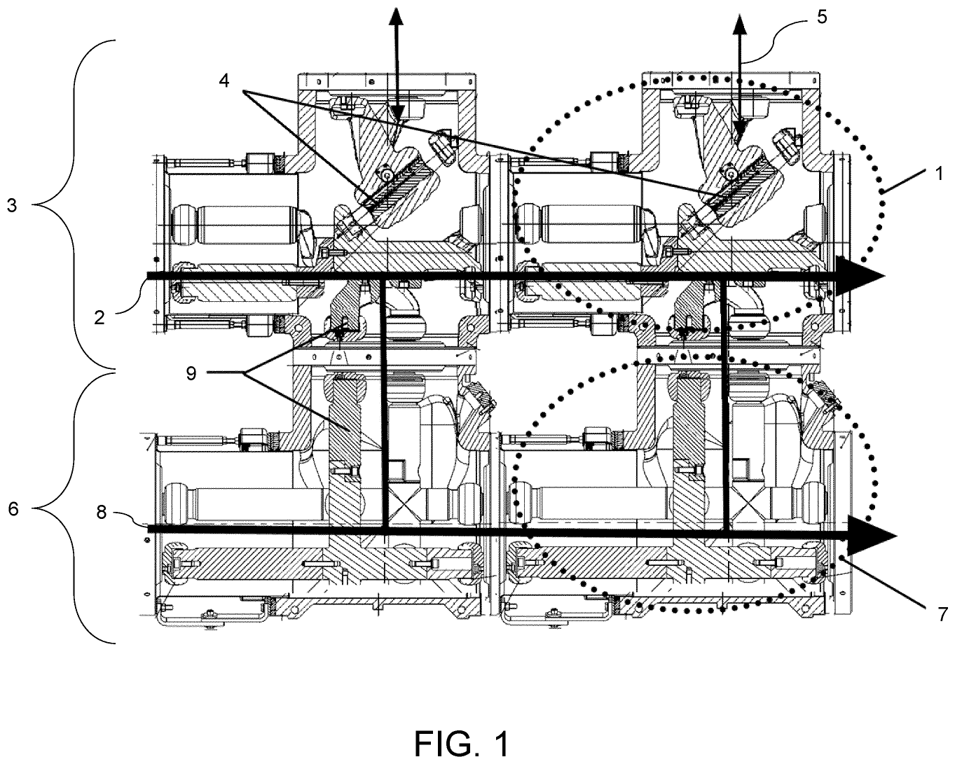

FIG. 1 shows a high voltage gas insulated switchgear, HV GIS, for single or three phase operation according to an implementation.

The HV GIS comprises a plurality of disconnector modules 1 associated to each phase, whereas FIG. 1 shows only one phase and only two disconnector modules 1 arranged besides each other. The disconnector modules 1 are filled with an insulating gas and are interconnected with a main bus bar 2 associated to each phase, indicated by bold arrow. The main bus bar 2 extends through and such wise connected all disconnector modules 1, which thereby form a main housing 3. Each disconnector module 1 further comprises a disconnector 4, which is configured for connecting a feeder connection 5 to the main bus bar 2, indicated by arrow. Such feeder connection 5 may for example connect a wind turbine to the HV GIS.

Separate from the main housing 3 an auxiliary housing 6 is provided, which is detachably attached the main housing 3. The auxiliary housing 6 comprises a plurality of auxiliary modules 7 associated to each phase, whereas FIG. 1 shows only one phase and only two auxiliary modules 7 arranged besides each other. The auxiliary modules 7 are also filled with the insulating gas and are interconnected with an auxiliary bus bar 8 associated to each phase. The auxiliary bus bar 8 extends through all auxiliary modules 7 thereby forming the auxiliary housing 6 for the respective phase with the insulating gas surrounding the auxiliary bus bar 8.

Each one respective main housing 3 and auxiliary housing 6 are connected together with a respective coupling connection 9, indicated by vertical bold arrow, connecting the main bus bar 2 and the auxiliary bus 8. While FIG. 1 only shows one auxiliary housing 6, a plurality of auxiliary housings 6 can be provided attached to the main housing 3 with the respective auxiliary modules 7 connected in series and/or in parallel to the respective disconnector module 1.

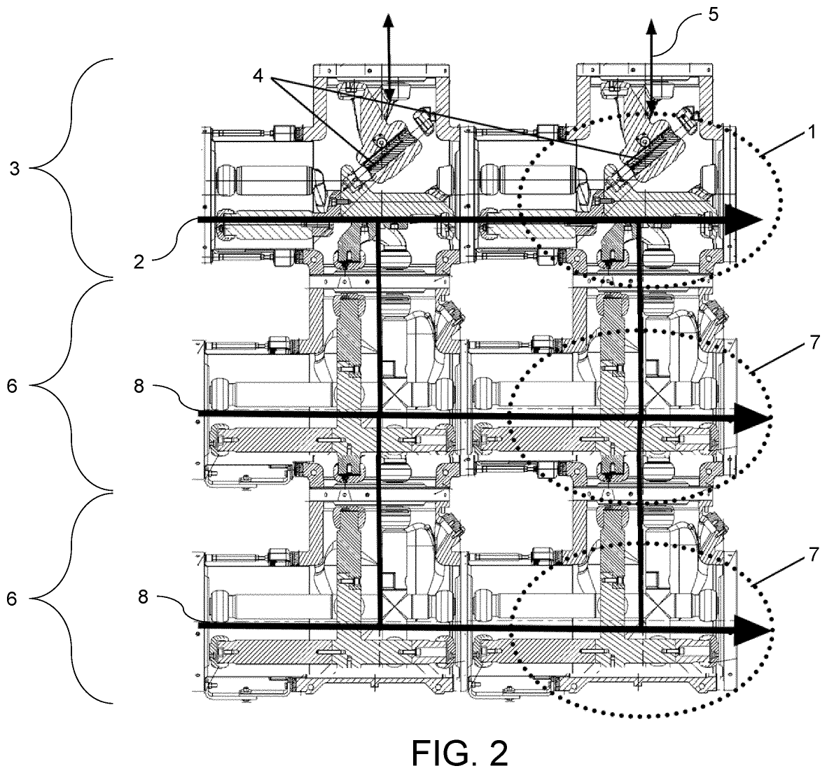

FIG. 2 shows a further example implementation of such high voltage gas insulated switchgear, HV GIS, having one main housing 3 and two auxiliary housings 6 connected in parallel.

While not shown, further auxiliary housings 6 can be connected in parallel as well, depending on current ratings.

In a further not shown implementation the auxiliary housings 6 may not extend over the full length of the HV GIS. This means that the auxiliary housings 6 may only be attached to some of the main housings 3, in particular in areas where the current is to be higher than rated current of the main housing 3 module. It is also possible to prepare the HV GIS for later upgrade by additional auxiliary housings 6 if the main housing 3 modules are planned with a fourth flange in front close by a cover. It thus becomes possible to add the auxiliary housing 6 modules later if the power demands has increased over time.

While the disclosure has been illustrated and described in detail in the drawings and foregoing description, such illustration and description are to be considered illustrative or exemplary and not restrictive; the disclosure is not limited to the disclosed implementations. Other variations to be disclosed implementations can be understood and effected by those skilled in the art in practicing the claimed embodiments, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 disconnector module
2 main bus bar
3 main housing
4 disconnector
5 feeder connection
6 auxiliary housing
7 auxiliary module
8 auxiliary bus bar
9 coupling connection

1. High voltage gas insulated switchgear, HV GIS, for single or three phase operation, comprising
a plurality of disconnector modules associated to each phase, whereby the disconnector modules are filled with an insulating gas, each disconnector module comprises a disconnector configured for connecting a feeder connection to a main bus bar and the disconnector modules are interconnected with the main bus bar associated to each phase and extending through all disconnector modules thereby forming a main housing for the respective phase with the insulating gas surrounding the main bus bar, and
a plurality of auxiliary modules associated to each phase, whereby the auxiliary modules are filled with the insulating gas and are interconnected with an auxiliary bus bar configured for increasing a current carrying capability of the HV GIS and associated to each phase and extending through all auxiliary modules thereby forming an auxiliary housing for the respective phase detachably attached and/or provided separate to the main housing with the insulating gas surrounding the auxiliary bus bar, whereby
at least two of the disconnector modules and auxiliary modules of the respective phase comprise a coupling connection connecting the main bus bar and the auxiliary bus bar between the respective disconnector module and the respective auxiliary module.

2. (canceled)

3. HV GIS according to claim 1, comprising a plurality of auxiliary housings attached to the main housing with the respective auxiliary modules connected in series and/or in parallel to the respective disconnector module.

4. HV GIS according to claim 1, whereby the auxiliary modules are connected to the disconnector modules on the opposite side to the feeder connection.

5. HV GIS according to claim 1, whereby the auxiliary modules and the disconnector modules are interconnected with the insulating gas surrounding the coupling connections.

6. HV GIS according to claim 1, whereby all disconnector modules and auxiliary modules are connected by the respective coupling connection or whereby the disconnector modules and auxiliary modules are connected in regular intervals by the respective coupling connection.

7. HV GIS according to claim 1, whereby the main bus bar and the auxiliary bus bar extend parallel to each other and/or the coupling connection extends perpendicular to the main bus bar and/or the auxiliary bus bar.

8. HV GIS according to claim l, whereby the disconnector module comprises a circuit breaker and/or an earthing switch connected to the main bus bar.

9. HV GIS according to claim 1, whereby the main bus bar is configured for a rating of at least 3000 A and/or the auxiliary bus bar is configured for a rating of at least 2500 A.

10. HV GIS according to claim 1, whereby the insulating gas comprises at least one of SF6, Airplus C5K, C4FN, CO2-O2 and pressurized air and/or any mixture thereof.

11. Method for operating a high voltage gas insulated switchgear, HV GIS, the method comprising:
providing a plurality of disconnector modules associated to each phase, whereby the disconnector modules are filled with an insulating gas, each disconnector module comprises a disconnector configured for connecting a feeder connection to a main bus bar and the disconnector modules are interconnected with the main bus bar associated to each phase and extending through all disconnector modules thereby forming a main housing for the respective phase with the insulating gas surrounding the main bus bar, and
providing a plurality of auxiliary modules associated to each phase, whereby the auxiliary modules are filled with the insulating gas and are interconnected with an auxiliary bus bar configured for increasing a current carrying capability of the HV GIS and associated to each phase and extending through all auxiliary modules thereby forming an auxiliary housing for the respective phase detachably attached and/or provided separate to the main housing with the insulating gas surrounding the auxiliary bus bar, whereby
at least two of the disconnector modules and auxiliary modules of the respective phase comprise a coupling connection connecting the main bus bar and the auxiliary bus bar between the respective disconnector module and the respective auxiliary module.

12. Wind turbine comprising:
a feeder connection; and
a high voltage gas insulated switchgear, HV GIS, comprising:
a plurality of disconnector modules associated to each phase, whereby the disconnector modules are filled with an insulating gas, each disconnector module comprises a disconnector connecting the feeder connection to a main bus bar and the disconnector modules are interconnected with the main bus bar associated to each phase and extending through all disconnector modules thereby forming a main housing for the respective phase with the insulating gas surrounding the main bus bar, and
a plurality of auxiliary modules associated to each phase, whereby the auxiliary modules are filled with the insulating gas and are interconnected with an auxiliary bus bar configured for increasing a current carrying capability of the HV GIS and associated to each phase and extending through all auxiliary modules thereby forming an auxiliary housing for the respective phase detachably attached and/or provided separate to the main housing with the insulating gas surrounding the auxiliary bus bar, whereby
at least two of the disconnector modules and auxiliary modules of the respective phase comprise a coupling connection connecting the main bus bar and the auxiliary bus bar between the respective disconnector module and the respective auxiliary module.

13. Wind turbine according to claim 12, comprising a plurality of auxiliary housings attached to the main housing with the respective auxiliary modules connected in series and/or in parallel to the respective disconnector module.

14. Wind turbine according to claim 12, whereby the auxiliary modules are connected to the disconnector modules on the opposite side to the feeder connection.

15. Wind turbine according to claim 12, whereby the auxiliary modules and the disconnector modules are interconnected with the insulating gas surrounding the coupling connections.

16. Wind turbine according to claim 12, whereby all disconnector modules and auxiliary modules are connected by the respective coupling connection or whereby the disconnector modules and auxiliary modules are connected in regular intervals by the respective coupling connection.

17. Wind turbine according to claim 12, whereby the main bus bar and the auxiliary bus bar extend parallel to each other and/or the coupling connection extends perpendicular to the main bus bar and/or the auxiliary bus bar.

18. Wind turbine according to claim 12, whereby the disconnector module comprises a circuit breaker and/or an earthing switch connected to the main bus bar.

19. Wind turbine according to claim 12, whereby the main bus bar is configured for a rating of at least 3000 A and/or the auxiliary bus bar is configured for a rating of at least 2500 A.

20. Wind turbine according to claim 12, whereby the insulating gas comprises at least one of SF6, Airplus C5K, C4FN, CO2-O2 and pressurized air and/or any mixture thereof.
